(19) United States
(12) Patent Application Publication
(10) Pub. No.: US 2012/0279932 A1
(43) Pub. Date: Nov. 8, 2012

(54) SYSTEM AND METHOD FOR DRYING DRILL CUTTINGS

(76) Inventor: Daniel Guy Pomerleau, Calgary (CA)

(21) Appl. No.: 13/551,194

(22) Filed: Jul. 17, 2012

Related U.S. Application Data
(62) Division of application No. 13/098,014, filed on Apr. 29, 2011.
Application No. 13/098,014 is a continuation of application No. PCT/CA2009/001555, filed on Oct. 29, 2009.
(60) Provisional application No. 61/109,365, filed on Oct. 29, 2008.

(51) Int. Cl. E21B 21/06; B01D 33/03

(52) U.S. Cl. 210/785

(57) ABSTRACT

An apparatus and method for separating drilling fluid from drill cuttings using pressurized air and/or a vacuum. In a first embodiment, the apparatus provides for improved separation of drilling fluid from drill cuttings on a shaker, the shaker including a shaker screen, an air vacuum system and a drilling fluid collection system. In a second embodiment, the shaker includes a shaker screen and an air blowing system.

### CROSS-REFERENCE TO RELATED APPLICATIONS

This application is a divisional of pending U.S. patent application Ser. No. 13/098,014 filed Apr. 29, 2011, which is a continuation of International patent application PCT/CA2009/001555 filed on Oct. 29, 2009 which designates the United States and claims the benefit under 35 U.S.C. §119 (e) of U.S. Provisional Patent Application Ser. No. 61/109,365, filed on Oct. 29, 2008. All prior applications are herein incorporated by reference in their entirety.

### FIELD OF THE INVENTION

The invention describes systems and methods for separating drilling fluid from drill cuttings using pressurized air and/or a vacuum.

The loss of drilling fluids presents several expensive challenges to the energy exploration industry as a result of the loss of drilling fluids to the formation and/or from the disposal of drilling detritus or cuttings that are contaminated with drilling fluid. In the context of this description, “drilling fluid” is both fluid prepared at surface used in an unaltered state for drilling as well as all fluids recovered from a well that may include various contaminants from the well including water and hydrocarbons.

By way of background, during the excavation or drilling process, drilling fluid losses can reach levels approaching 300 cubic meters of lost drilling fluid over the course of a drilling program. With some drilling fluids having values in excess of $1000 per cubic meter, the loss of such volumes of fluids represents a substantial cost to drill operators. Drilling fluids are generally characterized as either “water-based” or “oil-based” drilling fluids that may include many expensive and specialized chemicals as known those skilled in the art. As a result, it is desirable that minimal quantities of drilling fluids are lost and many technologies have been employed to minimize drilling fluid losses both downhole and at surface.

One particular problem is the removal of drilling fluid and any hydrocarbons from the formation that may be adhered to the drill cuttings (collectively “fluids”) at the surface. The effective removal of various fluids from drill cuttings has been achieved by various technologies including scroll centrifuges, vertical basket centrifuges (VBC), vacuum devices, and vortex separators. Typically, these devices rent out at costs ranging from $1000 to $2000 per day. As a result, the recovery of fluids necessary to cover this cost requires that the recovered fluid value is greater than the equipment rental cost in order for the recovery technology to be economically justified. On excavation projects where large amounts of high-cost drilling fluid are being lost (for example in excess of 3 cubic meters per day) then daily rental charges can produce something close to a balanced value.

However experience shows that the most aggressive and best recovery technologies like the VBC, and vacuum systems often produce a recovered fluid that must be processed by further equipment such as a scrolling centrifuge to remove very fine drilling detritus from the recovered fluid. This adds additional cost for processing increases the complexity of fluid recovery.

Moreover, in excavation operations where less than about 3 cubic meters of losses are occurring on a daily basis, the current technologies generally price themselves outside of customer tolerances.

Further still, the volume of hydrocarbons that may be adhered to drill cuttings may be of significant commercial value to warrant effective recovery. As well, with increasing environmental requirements with respect to the remediation of drill cuttings, effective and economic cleaning systems are increasingly needed.

Past techniques for removing drilling fluid from drill cuttings have also involved the use of liquid spraying systems that are used to deliver “washing” liquids to drill cuttings as they are processed over shaker equipment. Such washing liquids and associated fluid supply systems are used to deliver various washing fluids as the cuttings are processed over a shaker and can include a wide variety of designs to deliver different washing fluids depending on the type of drilling fluid being processed. For example, washing liquids may be comprised of oil, water, or glycol depending on the drilling fluid and drill cuttings being processed over the shaker.

Generally, these washing fluids are applied to reduce the viscosity and/or surface tension of the fluids adhered to the cuttings and allow for more fluids to be recovered.

Unfortunately, these techniques have been unable to be cost effective for many drilling fluids as the use of diluting fluids often produces unacceptable increases in drilling fluid volume and/or changes in chemical consumption of the drilling fluid.

As a result, there has been a need to develop a low-cost retrofit technology which can enhance fluid recovery and do so at a fractional cost level to mechanisms and technologies currently employed.

### SUMMARY OF THE INVENTION

In accordance with the invention systems and methods for separating drilling fluid from drill cuttings using pressurized air and/or a vacuum are described.

In a first aspect, the invention provides an apparatus for improving the separation of drilling fluid from drill cuttings on a shaker, the apparatus comprising: a shaker screen having an upper side and a lower side for supporting drilling fluid contaminated drill cuttings within a shaker; an air vacuum system operatively positioned under the shaker screen for pulling an effective volume of air through the shaker screen to enhance the flow of drilling fluid through the shaker screen and the separation of drilling fluid from drill cuttings; and, a drilling fluid collection system for collecting the separated drilling fluid from the underside of the screen.

In a further embodiment, the air vacuum system includes a vacuum manifold for operative connection to a portion of the shaker screen, a vacuum hose operatively connected to the vacuum manifold and a vacuum pump operatively connected to the vacuum hose. The air vacuum system may include at least two vacuum manifolds.

In one embodiment, the air vacuum system includes a drilling fluid separation system for removing drilling fluid from the vacuum hose. In another embodiment, the vacuum pump is adjustable to change the vacuum pressure.

In other embodiments, the vacuum manifold is adapted for configuration to the shaker screen across less than one third of the length of the shaker screen and may include a positioning system for altering the position of the vacuum manifold with respect to the shaker screen.

In yet another embodiment, the shaker screen includes a shaker frame and the shaker frame and associated shaking members are manufactured from composite materials.

In another embodiment, the apparatus further comprises an air blowing system operatively positioned over the shaker screen upper side for blowing an effective volume of air over drilling fluid contaminated drill cuttings passing over the shaker screen first to enhance the separation of drilling fluid from the drill cuttings. The air blowing system preferably includes at least one air distribution system comprising at least one air distribution bar and a plurality of air nozzles operatively positioned across the width of the shaker screen and may also include an air containment system operatively surrounding the at least one air distribution bar for containing drill cuttings and drilling fluid adjacent the upper side of the shaker screen. An air heating system may also be provide to heat the air distributed through the air blowing system.

In another aspect, the invention provides a method for improving the separation of drilling fluid from drill cuttings on a shaker, the method comprising the steps of:

a) applying an effective air vacuum pressure to a lower surface of a shaker screen supporting drilling fluid contaminated drill cuttings to enhance the flow of drilling fluid through the shaker screen and the separation of drilling fluid from drill cuttings;

b) collecting drill cuttings from an upper side of the screen; and,

c) collecting the drilling fluid from a lower side of the screen.

In another embodiment, the method includes the step of applying an effective volume of air to the upper surface of the shaker screen to enhance the flow of drilling fluid through the shaker screen and the separation of drilling fluid from drill cuttings.

### BRIEF DESCRIPTION OF THE DRAWINGS

The invention is described by the following detailed description and drawings wherein:

FIG. 1 is a perspective view of a shaker in accordance with the prior art that may be retrofit to include an air blowing system and/or vacuum system in accordance with the invention;

FIG. 2 is a plan view of a shaker including an air blowing system in accordance with a first embodiment of the invention;

FIG. 3 is an end view of a shaker including an air blowing system in accordance with a first embodiment of the invention;

FIG. 4 is a bottom view of a vacuum manifold and frame in accordance with a second embodiment of the invention;

FIG. 4A is an end view of a vacuum manifold and frame in accordance with a second embodiment of the invention;

FIGS. 5 A and 5B are schematic side views of a vacuum system in accordance with two embodiments of the invention;

FIG. 6 is a bottom view of a screen frame in accordance with one embodiment of the invention; and

FIG. 7 is a table showing a cost analysis of vacuum-processed drilling fluid as compared to a prior art processing method.

### DETAILED DESCRIPTION OF THE INVENTION

In accordance with the invention and with reference to the figures, embodiments of an improved drilling fluid recovery method and apparatus are described.

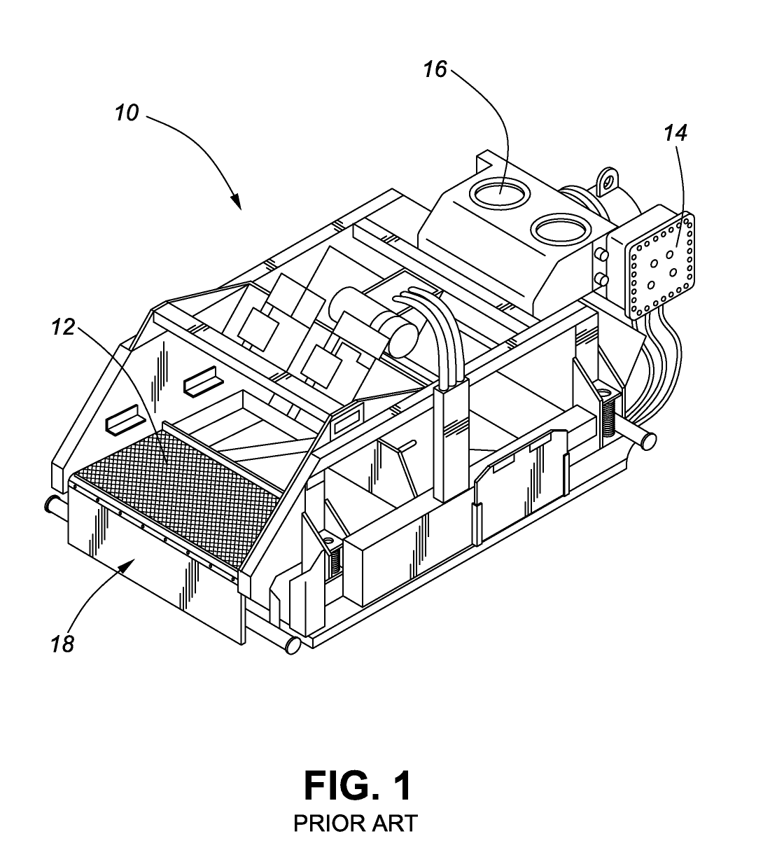

The invention solves various technical problems of prior approaches to cleaning drill cuttings and recovering drilling fluids at the surface during drilling operations, and particularly problems in conjunction with known shaker systems. FIG. 1 shows a known shaker 10 having a generally flat screen bed 12 over which recovered drilling fluid and drill cuttings are passed. The shaker 10 typically includes a dual motion shaking system 14 to impart mechanical shaking energy to the screen bed. Recovered drilling fluid and cuttings are introduced through entry ports 16 to the flat screen bed. The vibrating motion of the shaker and screen bed effects separation of the drill cuttings and fluids wherein the drilling fluid passes through the screen bed and is recovered from the underside of the shaker 10 and drill cuttings are recovered from the end 18 of the screen bed. In addition to gravity, the vibrating motion of the screen bed imparts mechanical energy to the drill cutting particles to “shake-loose” fluids that may be adhered to the outer surfaces of the drill cuttings. Drilling fluids will flow by gravity through the screen.

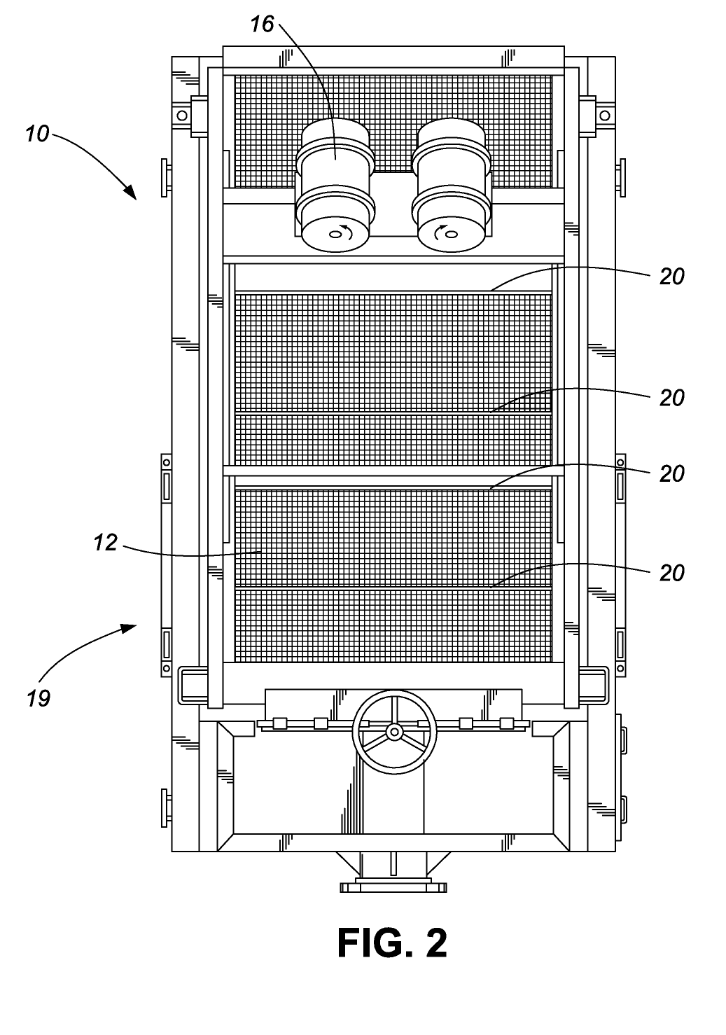

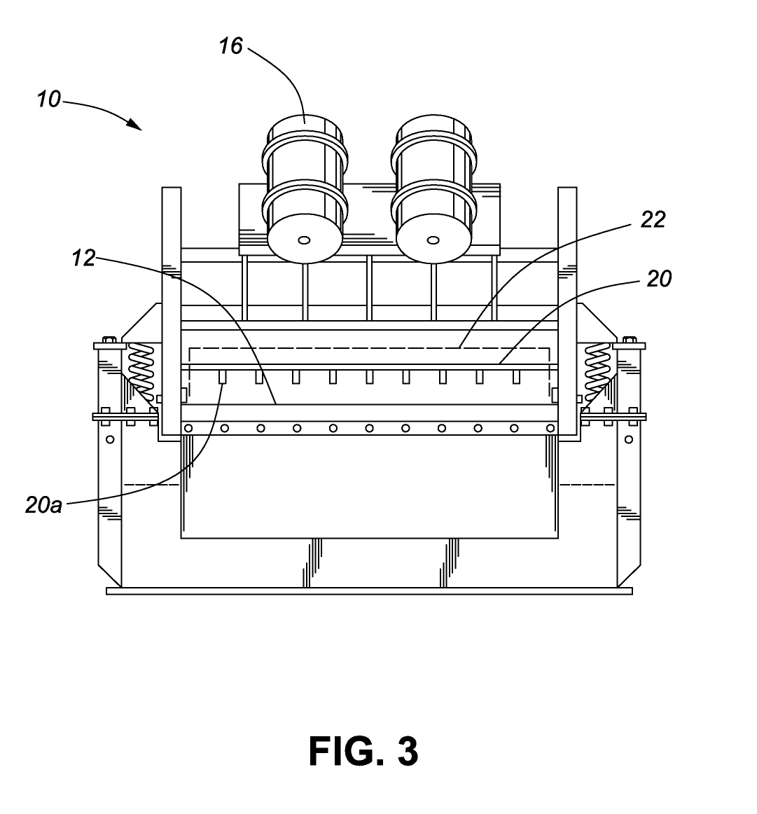

In accordance with a first aspect of the invention as shown in FIGS. 2 and 3, in order to improve the separating energy, the shaker is provided with a compressed air system 19. The compressed air system blows compressed air over the cuttings being processed by a shaker wherein high and/or low pressure air is used to cause the effective separation of drilling fluid from drill cuttings. Generally, compressed air is supplied by a compressor (not shown) and is blown through appropriate distribution bars 20 and nozzles 20a at a close distance to the screen bed 12 such that fluids adhered to the drill cuttings are effectively blown off the drill cuttings as they traverse the shaker 10 by being subjected to a high shearing energy as air impacts the drill cuttings.

As shown, the system may employ multiple distribution bars and nozzles operating at similar or dissimilar pressures and positioned at different locations and angles on the shaker in order to provide effective separation. The air may also be heated in order to assist in lowering the viscosity and, hence, surface tension of the fluids on the cuttings.

Depending on the drill fluid, an alternate air blowing system utilizing fans (not shown) may be employed as appropriate and may include appropriate heating systems as above.

The system may be operated in conjunction with other past technologies including washing fluids, although this would only be employed if the economics are favorable.

In the case where high pressure, high velocity air is employed, it may be necessary to include appropriate shields, deflectors or porous trays to ensure that the cuttings are not blown out of the shaker and to ensure that the air pressure flow is effectively directed to process all drill cuttings. Similarly, the system may include collection systems to ensure that vaporized and condensed drilling fluid is re-collected.

In one embodiment, the system may include a hovercraft-style skirt 22 (shown with a dotted line) to contain drill cuttings within the skirt to promote effective processing of the cuttings. In this embodiment, the hovercraft skirt 22 would “float” above the shaker screen and high pressure air would be directed towards the screen.

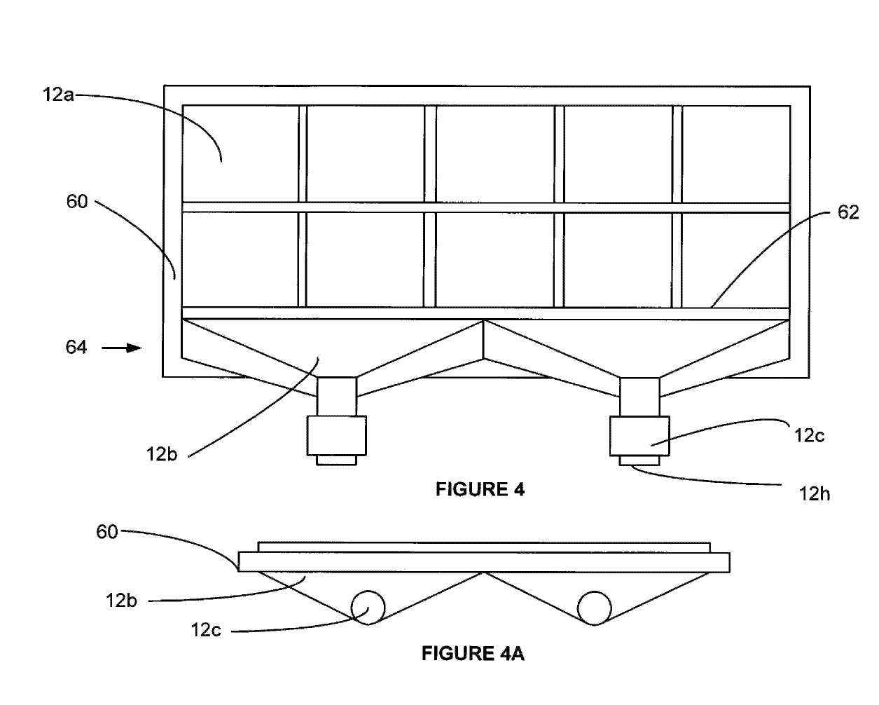

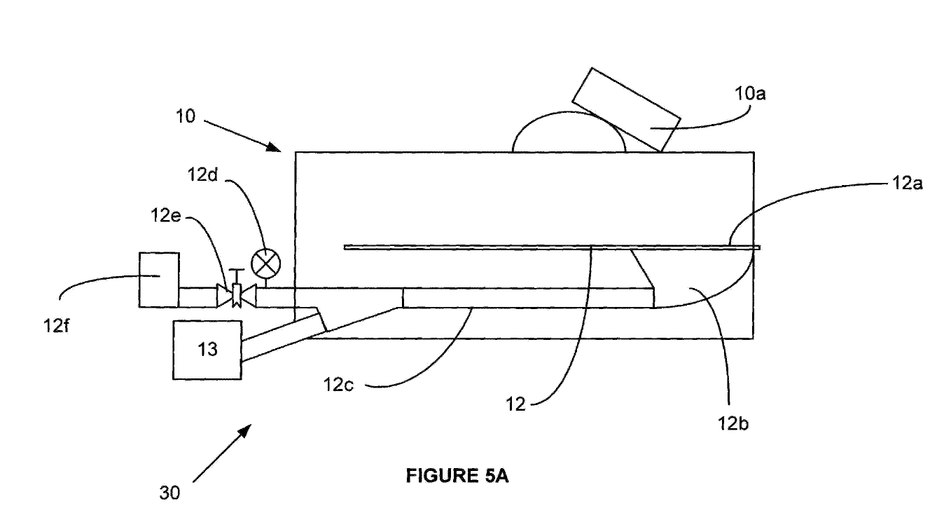

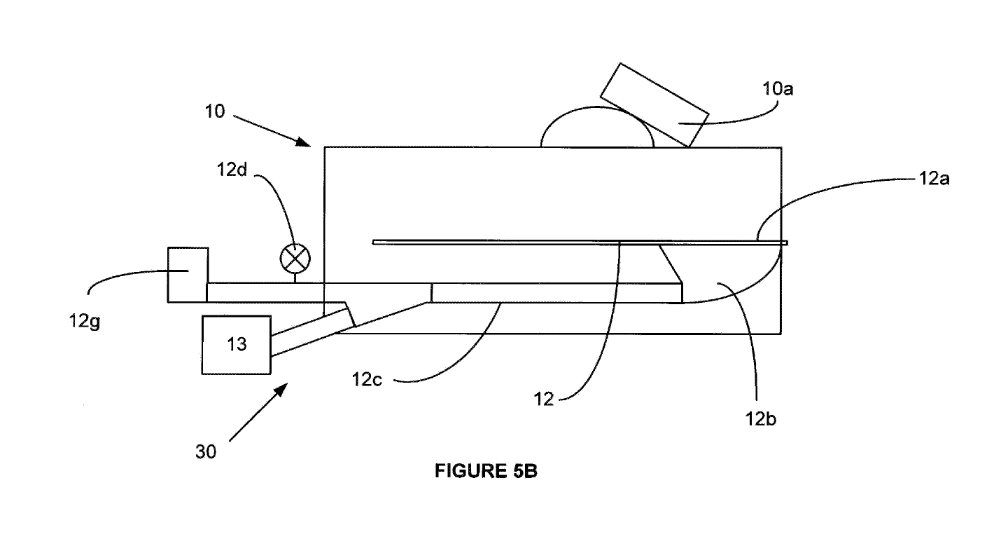

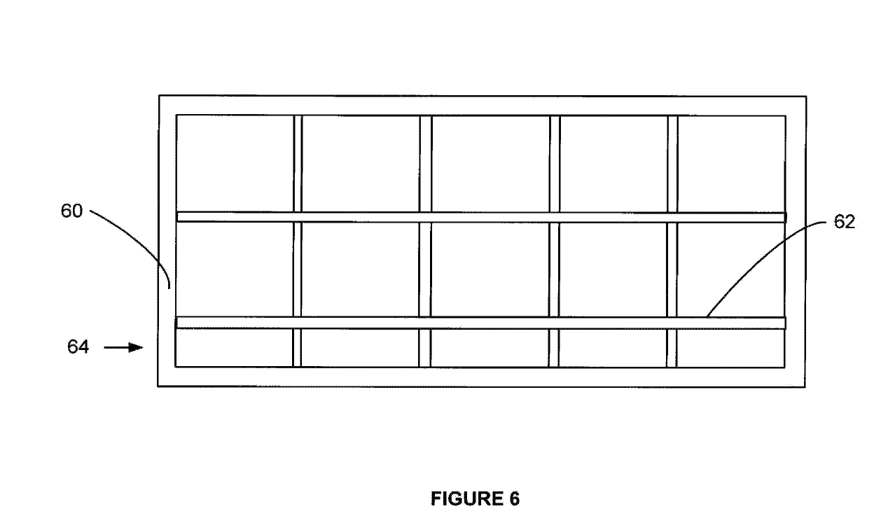

In a second aspect, as described in FIGS. 4-6, the shaker is provided with a vacuum system 30 located below the screen bed 12 to enhance the flow of drilling fluid through the screen and to strip drilling fluid from the drill cuttings. As shown in FIGS. 4 and 4A, a screen 12a is provided with at least one vacuum manifold 12b for applying a vacuum pressure to the underside of a portion of the screen 12a. That is, the vacuum manifold is designed to connect to the underside of a screen in order that as cuttings and fluids pass over the screen, a vacuum pressure encourages the passage of drilling fluid through the screen, hence improving the efficiency of separation. In addition, the vacuum pressure may be sufficient to effectively break the surface tension of fluids adhering to the drill cuttings particles applied during shaking so as to further improve the separation of fluids from the drill cuttings. In FIG. 4, the horizontal length of the vacuum manifold is designed to apply a vacuum across a relatively small portion of the total horizontal length of the screen (approximately 1 inch as shown in FIG. 4) whereas as shown in FIGS. 5 A and 5B, the manifold has a longer horizontal length of approximately 7 inches (approximately one third of the length of the screen).

Preferably, separate vacuum manifolds are utilized across the screen to ensure a relatively even vacuum pressure is applied across the screen.

As shown schematically in FIGS. 5 A and 5B, seiving screen(s) 12 is/are operatively attached to a vacuum manifold 12b with a fluid conveyance tube/vacuum tube 12c with a vacuum gauge 12d and a fixed vacuum device 12f together with a variable control vacuum device 12g (FIG. 5A) or variable vacuum device 12g (FIG. 5B). Both embodiments have a fluid collection system 13 that allows recovered drilling fluid to be separated by gravity from the vacuum system to a storage tank for re-use. A vibration motor 10a drives the vibration of the screen 12.

The vacuum adjustment system 12e can be a restrictive orifice or a controlled air/atmospheric leak into the vacuum line as known to those skilled in the art. A restrictive orifice constricts flow and leads to a build up in the vacuum line, while a controlled atmospheric leak does not restrict flow. The vacuum gauge 12d is useful for tuning but is not absolutely necessary.

Vacuum to Screen Interface and Screen Design

As shown in FIGS. 4 and 4 A, a vacuum manifold 12b is adapted for configuration to a screen 12 by a vacuum manifold support frame 60. The vacuum manifold support frame 60 includes a bisecting bar 62 defining a vacuum area 64 and open area 66. The vacuum manifold 12b has a generally funnel-shaped design allowing fluids passing through the screen to be directed to vacuum hose 12c. The upper edge of the vacuum manifold includes an appropriate connection system for attachment to the frame 60 such as a mating Hp and clamping system permitting the vacuum manifold to be seated and locked within the frame without shaking loose during operation. The lower exit port 12h of the vacuum manifold is provided with an appropriate tube connection system and lock such as a lip and cam lock for attaching a vacuum hose 12c to the manifold. A screen is mounted and secured to the upper surfaces of the frame.

### EXAMPLES

A trial of the vacuum screen was made during a drilling operation at Nabors 49, a drilling rig in the Rocky Mountains of Canada. The trial was conducted while the rig was drilling and an oil-based Invert Emulsion drilling fluid was used. The drilling fluid properties from the well used during drilling are shown in Table 1 and are representative of a typical drilling fluid for a given viscosity.

TABLE 1
Drilling Fluid Properties

| | |
|---|---|
| Depth | 4051 m |
| T.V. Depth | 3762 m |
| Density | 1250 kg/m³ |
| Gradient | 12.3 kPa/m |
| Hydrostatic | 46132 kPa |
| Funnel Viscosity | 45 s/l |
| Plastic Viscosity | 10 Mpa · s |
| Yield Point | 2 P |
| Gel Strength | 1/1.5 Pa 10 s/10 min |
| Oil/Water Ratio | 90:10 |
| HTHP | 16 ml |
| Cake | 1 mm |
| Chlorides | 375714 mg/l |
| Sand Cont | trace |
| Solids Cont | 12.88% |
| High Density | 402 kg/m³ (9.46 wt %) |
| Low Density | 89 kg/m³ (3.42%) |
| Flowline | 42° C. |
| Excess Lime | 22 kg/m³ |
| Water Activity | 0.47 |
| Electric Stability | 396 volts |
| Oil Density | 820 kg/m³ |

The test was conducted on a MI-Swaco Mongoose Shaker.

For the test, only one side of the vacuum system was connected so that representative samples could be collected from both sides of the screen to give a quantitative and qualitative assessment of the effect of vacuum on separation.

The vacuum system included a Westech S/N 176005 Model: Hibon vtb 820 vacuum unit (max. 1400 CFM). The vacuum unit was pulling at 23 in. Hg. through a 22 inch×1 inch vacuum manifold during the test. An 80 mesh screen (i.e. open area of 50% such that the actual flow area through the screen was 0.07625 ft²). During operation, the cuttings stream transited this vacuum gap in about 3 seconds.

Samples were collected during the test and there was a visible difference between those processed over the vacuum bar and those which passed through the section without being subjected to a vacuum.

Qualitatively, the vacuum-processed cuttings were more granular and dryer whereas the un-processed cuttings (i.e. no vacuum) had a slurry-like texture typical of high oil concentration cuttings.

The recovered test samples were then distilled (50 ml sample) using a standard oil field retort. The field retort analysis is summarized in Table 2.

TABLE 2
Trial Test Results

| | | | | | | | | Recovered | Recovered |
|---|---|---|---|---|---|---|---|---|---|
| | | | | | | | | Oil wt %/ | Oil vol %/ |
| | Sample | Oil | Water | Oil | Oil | | | Wt % of | vol % of |
| Test | (g) | (ml) | (ml) | g/cc | (g) | Oil % | Water % | cuttings | cuttings |
| 1 | 90 | 14.5 | 2.9 | 0.82 | 11.9 | 88 | 12 | 13.18 | 29.00 |
| (vacuum) | | | | | | | | | |
| 2 (no | 97 | 18.9 | 2.1 | 0.82 | 15.5 | 90 | 10 | 15.99 | 37.80 |
| vacuum) | | | | | | | | | |

These results show a significant effect in about 3 seconds of exposure of vacuum. In particular, test 1 showed that vacuum resulted in an approximately 8 volume % improvement in oil recovery from the vacuumed cuttings.

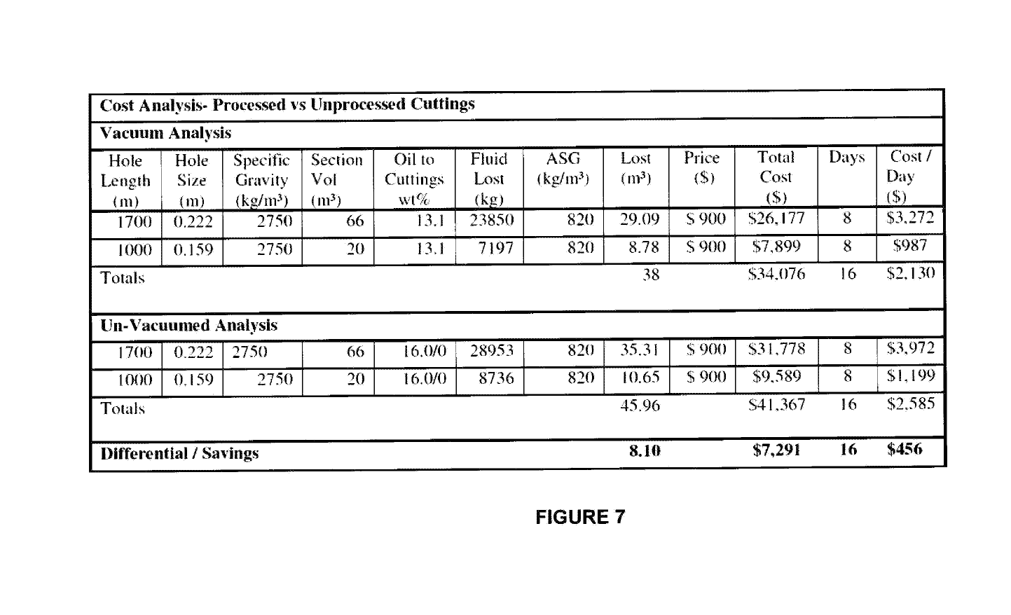

FIG. 7 shows an analysis of representative cost benefits realized by use of the separation system in accordance with the invention. As shown, drilling fluid volumes and drill cutting volumes are calculated based on a particular length of boreholes and borehole diameters.

FIG. 7 shows that over an 8 day drilling program, $7291 in fluid costs would be saved. As the bulk of prior art cuttings processing equipment requiring mobilization and demobilization costs as well as costing $1500-$2000 per day for rental fees, conventional cuttings equipment is not cost effective as a means of effectively reducing the overall costs of a drilling program. However, the system in accordance with the invention can be deployed at a significantly lower daily cost and hence allows the operator to achieve a net back savings on the fluid recovery.

During the trial it was found that excessive and/or an invariable vacuum pressure on the 1 inch screen could cause the vacuum screen to overcome screen vibration and to stall the cuttings on the screen thereby preventing effective discharge of cuttings from the shaker. As a result, the vacuum system and screen design as shown in FIGS. 5A and 5B, is preferred as greater control on the vacuum pressure can be effected.

Other Design and Operational Considerations

It is understood that an operator may adjust the vacuum pressure, screen size and/or vacuum area in order to optimize drilling fluid separation for a given field scenario.

Further still, a vacuum manifold may be adjustable in terms of its horizontal length and/or vertical position with respect to the underside of a screen. For example, a vacuum manifold may be provided with overlapping plates that would allow an operator to effectively widen or narrow the width of the manifold such that the open area of the manifold could be varied during operation through an appropriate adjustment system.

Safety

It is also preferred to include a gas detector (not shown) in the receiving area of the vacuum to detect buildup of harmful gases within the chamber.

Installation

It is also beneficial to install the vacuum system at a level below the height of the shaker to allow for collected fluid to flow as well as be drawn into the vacuum chamber. This would ensure that slow moving detritus/fluid would have less opportunity to collect in the hose system that exists between the vacuum means and the operative connection between the screen and vacuum.

In other embodiments, the vacuum zone may be linearly adjusted across the screen so as to enable the operator to optimize the cutting/fluid separation and, in particular, the time that the cuttings are exposed to a vacuum pressure.

In yet another aspect, the shaker may be constructed out of light weight materials such as composite materials as opposed to the steel currently used. The use of composite materials such as fiberglass, Kevlar and/or carbon fiber may provide a lower reciprocating mass of the shaker system (including the screen frame, and associated shaking members), allow for higher vibration frequencies to be employed by minimizing the momentum of the shaker and allow for more control of the amplitude of the shaker. That is, a composite design allows for higher vibrational frequencies to be transmitted to the drill cuttings and fluid that would result in a reduction of viscosity of the drilling fluids which are typically thixotropic in nature. The resulting decrease in viscosity would provide a greater degree of separation of fluid and cutting.

Still further, a composite shaker would be light enough to allow for strain gauge sensors and accelerometers to be located under the shake basket in order to track the flow of mass over the shaker in a way which would allow for the operator to know the relative amount of drilling detritus being discharged from the well on a continuous basis. This information can be used for adjusting fluid properties; typically viscosity, to optimize the removal of cuttings from the well bore during the excavation process.

Although the present invention has been described and illustrated with respect to preferred embodiments and preferred uses thereof, it is not to be so limited since modifications and changes can be made therein which are within the full, intended scope of the invention.

What is claimed is:

1. A method for improving the separation of drilling fluid from drill cuttings on a shaker, the method comprising the steps of:
a. applying an effective air vacuum pressure to a lower surface of a shaker screen supporting drilling fluid contaminated drill cuttings to provide an effective flow of air through the shaker screen to enhance the flow of drilling fluid through the shaker screen and the separation of drilling fluid from drill cuttings without stalling drill cuttings on the shaker screen;
b. collecting drill cuttings from an upper side of the screen; and,
c. collecting the drilling fluid from a lower side of the screen.

2. The method as in claim 1 wherein the shaker includes an air vacuum system including a vacuum manifold for operative connection to a portion of the shaker screen, a vacuum hose operatively connected to the vacuum manifold and a vacuum pump operatively connected to the vacuum hose, the method further comprising the step of controlling vacuum pressure in the vacuum hose to maintain flow in the vacuum hose.

3. The method as in claim 2 wherein the shaker includes a drilling fluid collection system operatively connected to the vacuum hose and the method further comprises the step of collecting drilling fluid within the drilling fluid separation system.
